(19) United States
(12) Patent Application Publication
(10) Pub. No.: US 2014/0329466 A1
(43) Pub. Date: Nov. 6, 2014

(54) ELECTRONIC APPARATUS WITH THE FUNCTION OF SWITCHING BETWEEN WIRED AND WIRELESS CONNECTION

(71) Applicant: DEXIN CORPORATION, NEW TAIPEI CITY (TW)

(72) Inventor: YUAN-JUNG CHANG, NEW TAIPEI CITY (TW)

(73) Assignee: DEXIN CORPORATION, NEW TAIPEI CITY (TW)

(21) Appl. No.: 13/887,304

(22) Filed: May 4, 2013

(51) Int. Cl. H04W 4/00

(52) U.S. Cl. CPC H04W 4/00
USPC 455/41.2; 455/39

(57) ABSTRACT

An electronic apparatus with the function of switching between a wired and wireless connection is disclosed. The electronic apparatus includes an electronic apparatus body, a wireless module and a charging battery. When the electronic apparatus is connected to a host from a plug connection part in a wired way, the electronic apparatus proceeds data communication with host in a wired way, or when the electronic apparatus is connected to the host wirelessly, the electronic apparatus proceeds data communication with host through the wireless module wirelessly. Moreover, through a software setting, a user may switch the function of the wire and wireless either by an auto-determination from a microcontroller of the electronic apparatus, or a mechanical switch.

### BACKGROUND OF THE DISCLOSURE

1. Field of the Disclosure

The instant disclosure relates to a wireless module; in particular, to an electronic apparatus having a wireless module with a function of switching between wired and wireless connection.

2. Description of Related Art

A wide application of computers is driven by a continuous development of technology. A mouse used as an input device brings great convenience to an operation executed by a user on the computer. During operation, the mouse is placed on a carrier and moved to control a cursor on a screen. With upgrading of electronic products, users also demand more from the electronic products, and therefore, with a simple look, a single function, and lack of originality, a mouse in prior art is no longer to satisfy demand of appearance and function.

The computer age has arrived, and the role played by the input device connected the computer and the user is also very important, including: a mouse, a keyboard and a trackball, and among which, the mouse is the mostly used and the easiest to learn. Nowadays, almost all mouses are with scroll wheels for control, such as controlling the scrolling on the screen. Furthermore, computers and the peripherals are becoming part of daily life of everyone, and mouses are connection between computers and users, which brings the mouses up to an even more important position, and therefore, major manufacturers in the computer related market consider the mouse valuable and make effort on developing a variety of new features for the mouses or making more user-friendly mouses, and among which, developing wireless mouses is a main objective. A traditional mouse is connected to a computer system with a cable; however, instead of a traditional cable, a wireless mouse has a wireless signal receiver corresponding to the wireless mouse. Without the cable, when using the wireless mouse, it is no longer restricted and even becoming very convenient, and there are many wireless devices in the field of computer peripheral devices, besides wireless mouses, there are also wireless headsets, wireless keyboards. Among the wireless devices, the wireless mouse is the mostly used wireless computer peripheral device.

### SUMMARY OF THE DISCLOSURE

The instant disclosure provides an electronic apparatus with a function of switching between wire and wireless connection. The electronic apparatus includes an electronic apparatus body, a wireless module, and a charging battery. The electronic apparatus body has a plug connection part, a first containing part, and a second containing part, and the electronic apparatus body connects to a host optionally. The wireless module is equipped in the first containing part, wherein a configuration setting of the electronic apparatus is operated by the wireless module through a software setting of a mobile device. The charging battery is equipped in the second containing part, providing power for the electronic apparatus. When the connection is wired and connected from the plug connection part to the host, the electronic apparatus proceeds data communication with the host in a wired way; when the connection is wireless and connected from the electronic apparatus to the host, the electronic apparatus proceeds data communication with the host through the wireless module in a wired way. Moreover, through a software setting, a user may switch between the wired and wireless connection through the software setting on the mobile device (such as a phone or a tablet pc), or an auto-determination from a microcontroller inside the mouse, or a mechanical switch.

In an embodiment of the instant disclosure, when an electronic apparatus is connected to a host in a wireless way, a wireless module is a wireless communication interface.

In an embodiment of the instant disclosure, the electronic apparatus body is a mouse, or a keyboard, or a headset, and the mobile device is either a phone or a tablet pc.

In an embodiment of the instant disclosure, when a plug connection part is connected to the host in a wired way, the host will charge the charging battery.

In an embodiment of the instant disclosure, a communication standard of a wireless module is either Bluetooth communication protocol or Zigbee communication protocol.

In an embodiment of the instant disclosure, the electronic apparatus body includes a signal processing module, connected to the wireless module and also connected to a charging battery through a charging circuit, the signal processing module processing a data communication between the electronic apparatus and the host, and a configuration setting function of the electronic apparatus.

An embodiment of the instant disclosure further provides an electronic apparatus, and the electronic apparatus includes an electronic apparatus body and a wireless module. The electronic apparatus body has a plug connection part and a containing part, and the electronic apparatus body is connected from the plug connection part to the host through a transmission line, wherein the electronic apparatus proceeds a data communication with the host through a transmission line. The wireless module is equipped in the containing part, wherein a configuration setting of the electronic apparatus is operated with a wireless module and through an operation of a software setting of the mobile device.

In an embodiment of the instant disclosure, the wireless module is data transmission channel.

To sum up, the electronic apparatus with the function of switching between a wired and wireless connection provided by the embodiments of the instant disclosure, along with the wireless module provided by the instant disclosure are able to achieve a simple configuration program setting, and the user will be able to switch between wired and wireless connection though operating a software setting on a mobile device, or through an auto-determination from a microcontroller on an electronic apparatus, or a mechanical switch, so as to adapt to different surroundings and bring up the convenience of operation.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

FIG. 1 shows a schematic diagram of a mouse according to an embodiment of the instant disclosure;

FIG. 2 shows a schematic diagram of a mouse circuit according to an embodiment of the instant disclosure;

FIG. 3 shows a schematic diagram of a mouse connecting to a host in a wired connection according to an embodiment of the instant disclosure;

FIG. 4 shows a schematic diagram of a mouse connecting to a host in a wireless connection according to an embodiment of the instant disclosure; and

FIG. 5 shows a schematic diagram of a mouse according to an embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

It is understood that when an element is described as “connected” or “coupled” to another element, the element may be directly connected to or directly coupled to another element, or there is an inserted element in this case. On the contrary, when an element is “directly connected to” or “directly coupled to” another element, then there is no inserted element in this case. It is so forth to explain similar ways of describing relation between elements such as “between” versus “directly between”, “adjacent” versus “directly adjacent.”

For better understanding of the instant disclosure, an electronic apparatus used for an embodiment of following instruction is a mouse, and people skilled in the art should be able to understand if the embodiment of an electronic apparatus with a function of switching wired and wireless connection is demonstrated with a keyboard or a headset.

[Embodiment of an Electronic Apparatus with a Mouse]

In at least one of embodiments of the instant disclosure, there is an electronic apparatus with a function of switching between wired and wireless connection, and the electronic apparatus includes an electronic apparatus body, a wireless module, and a charging battery. The electronic apparatus body has a plug connection part, a first containing part, and a second containing part, and the electronic apparatus body connects to a host optionally. In the instant disclosure, the wireless module is equipped in the first containing part so that a user may operate a software setting of a mobile device and execute a configuration setting of the electronic apparatus through the wireless module, wherein the mobile device may be a phone or a tablet. The charging battery is equipped in the second containing part, providing power for the electronic apparatus. When the electronic apparatus communicates with the host in a wired way, the wireless module plays a role of a wireless communication interface so that a user may run a configuration setting through the wireless module with a mobile device. When the electronic apparatus communicates to the host in a wireless way, the wireless module still plays a role of a wireless communication interface so that a user may also still run the configuration setting through the wireless module with the mobile device.

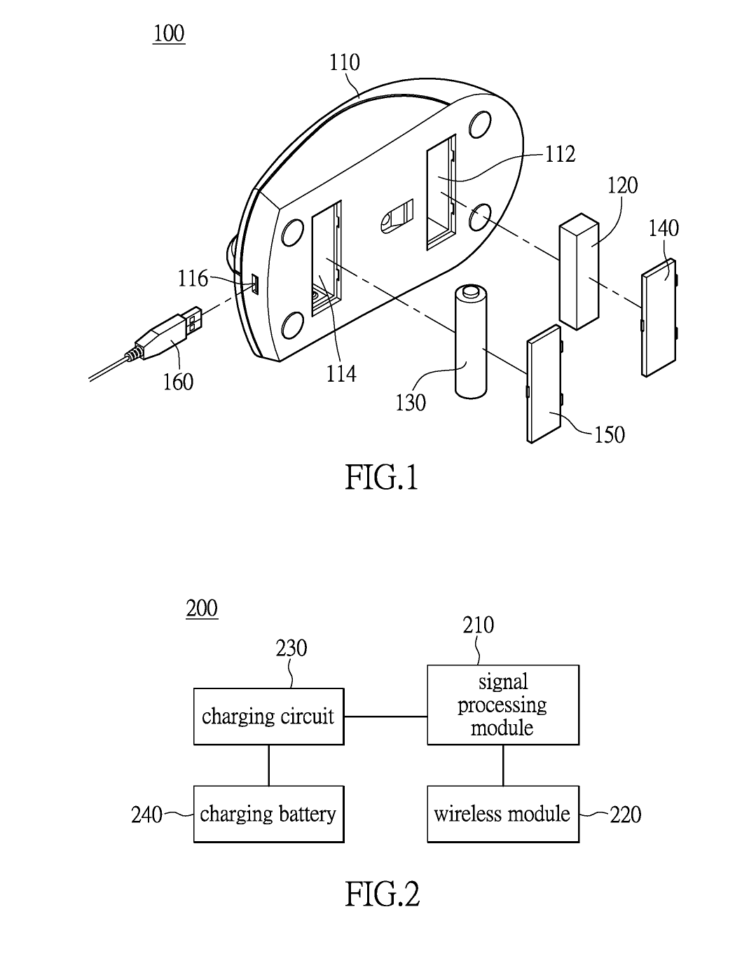

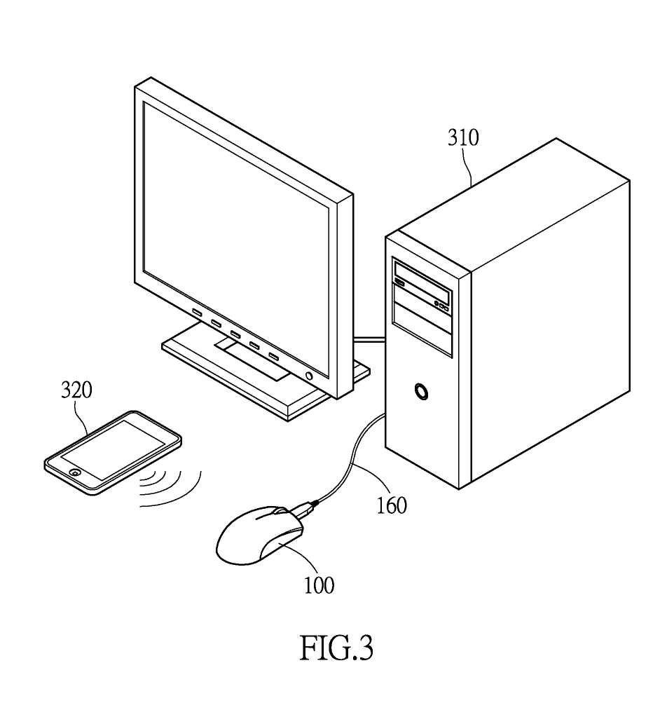

Referring to FIGS. 1 and 2, FIG. 1 shows a schematic diagram of a mouse according to an embodiment of the instant disclosure. FIG. 2 shows a schematic diagram of a mouse circuit according to an embodiment of the instant disclosure. The electronic apparatus 100 (mouse) includes an electronic apparatus body 110, a wireless module 120 and a charging battery 130, wherein in this embodiment, the electronic apparatus body 110 is a mouse body. The mouse body may be connected to a host optionally, which means that the mouse body may be connected to the host in a wired or wireless way. The wireless module 120 is equipped in a first containing part 112, a charging battery 130 is equipped in a second containing part 114, and the first containing part 112 and the second containing part 114 are respectively covered by a cover 140 and another cover 150, and it is worth mentioning that, the wireless module 120 and the charging battery 130 both equipped on the bottoms of the two containing parts are removable. Moreover, the mouse body has a plug connection part 116 which connects to the host through a transmission line 160, wherein the plug connection part 116 is such as a Universal Serial Bus (USB), a Mini USB, a Micro USB, or any other type of element which is able to transmit a signal and power simultaneously, and thus the embodiment is not limited by the type of the plug connection part 116.

As shown in FIG. 2, a mouse circuit 200 includes a signal processing module 210, a wireless module 220, a charging circuit 230, and a charging battery 240. The wireless module 220 is electrically connected to the signal processing module 210. The signal processing module 210 is electrically connected to the charging circuit 230. The charging circuit 230 is electrically connected to the charging battery 240. Please refer to FIGS. 1, 2, and 3 together for a better understanding of the instant disclosure, and FIG. 3 shows a schematic diagram of a mouse connecting to a host according to an embodiment of the instant disclosure. When the user switches the connection between the mouse and the host 310 to a wired way through the software setting on the mobile device (such as a phone or a tablet pc), or an auto-determination from a microcontroller inside the mouse, or a mechanical switch; at the moment, for the mouse with the charging battery 240, the wireless module 110 or 220 plays a role of wireless communication interface. Furthermore, the user is able to operate a mouse setting application on the phone or the tablet pc and run a configuration program setting through the wireless module 110 or 220, and the mouse with the charging battery 240 is able to proceed a data communication with the host 310 through the wireless module 110 or 220 (similar to a wireless mouse), or proceed the data communication with the host 310 through a transmission line 160 (which is optional and set by the user), wherein the configuration setting and the data processing work are both handed over to the signal processing module 210. In addition, since the mouse is connected from the plug connection part to the host in a wired way, a power supplier in the host 310 will charge the charging battery 240 through the charging circuit 230 to provide the needed power for the mouse. It is worth mentioning that, in the present embodiment, a communication standard of the wireless module 110 or 220 is either Bluetooth communication protocol or Zigbee communication protocol.

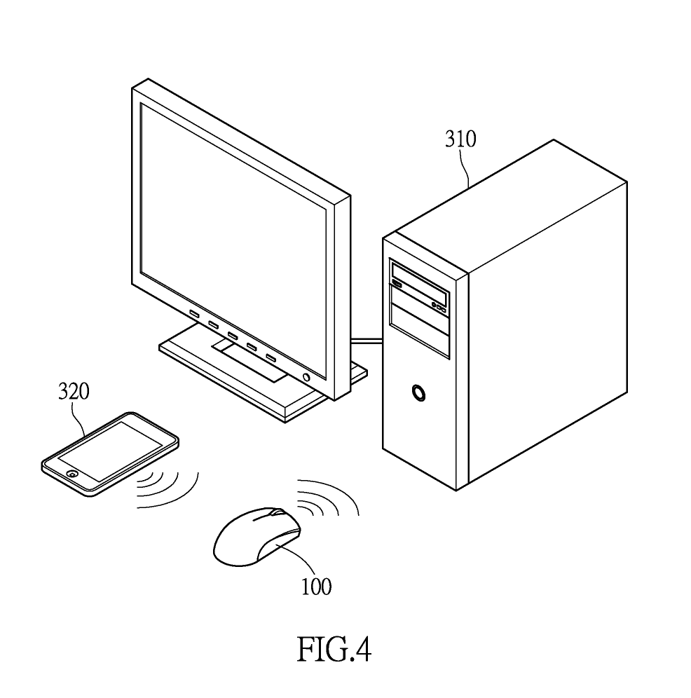

For the following description, please refer to FIGS. 1, 2, and 4 together for a better understanding of the instant disclosure, and FIG. 4 shows a schematic diagram of a mouse connecting to a host in a wireless connection according to an embodiment of the instant disclosure. When a user switches the connection between the mouse and the host 310 to a wireless way through the software setting on the mobile device (such as a phone or a tablet pc), or an auto-determination from a microcontroller inside the mouse, or a mechanical switch; at the moment, there is no need for the element of transmission line 160 in the embodiment. For the mouse with the charging battery 240, the wireless module 110 or 220 still plays a role of wireless communication interface. Furthermore, the user is able to operate a mouse setting application on the phone or the tablet pc and run a configuration program setting through the wireless module 110 or 220, and it is able to proceed a data communication with the host 310 through the wireless module 110 or 220, wherein the data processing work is handed over to the signal processing module 210.

It is worth mentioning that, when the charging battery 240 inside the mouse is almost out of power, the user is able to switch the connection between the mouse and the host 310 to a wired way through the software setting on the mobile device (such as a phone or a tablet pc), or an auto-determination from a microcontroller inside the mouse, or a mechanical switch, and to connect the mouse and the host 310 with the transmission line 160, so that the power supplier on the host 310 will charge the charging battery 240 through the charging circuit 230 to provide the needed power for the mouse.

It is worth noticing that, the auto-determination of the microcontroller is that a detector (not shown) used for detecting if the transmission line 160 of the mouse coming off the plug connection part 116; if it is, the wireless mouse mode is turned on; otherwise, when the detector is able to detect the transmission line 160 connected to the plug connection part 116, the wired mouse mode will be the choice.

There will be another embodiment for describing a mouse without the charging battery 240 in the following paragraphs.

In the following embodiments, there are only those parts which are different from the embodiments in FIGS. 1-4 descried, and the omitted parts are indicated to be identical to the embodiments in FIGS. 1-4. Moreover, for an easy instruction, similar numbers or symbols are indicated to be the similar elements.

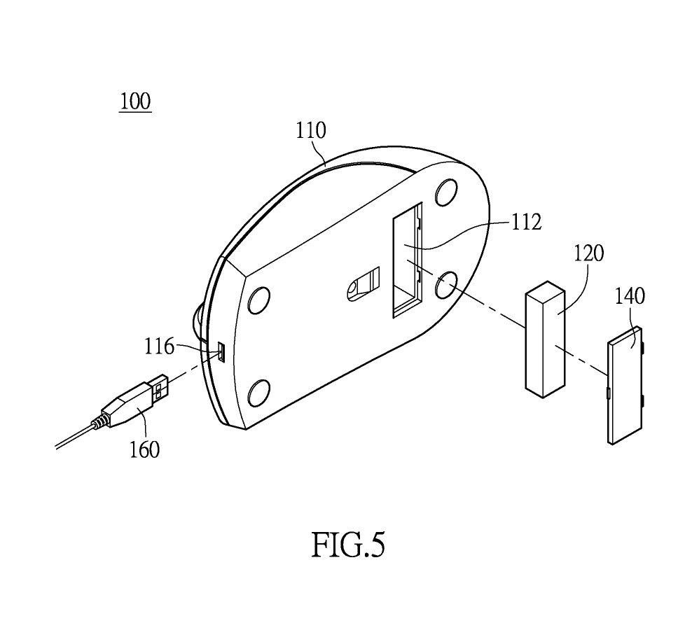

Referring to FIG. 5, FIG. 5 shows a schematic diagram of a mouse according to an embodiment of the instant disclosure. Different from FIG. 1, an electronic apparatus 100 (mouse) includes an electronic apparatus body 110 and a wireless module 120, and there is no such element as a charging battery, but a user is still able to execute a configuration program setting with a mouse setting program on a phone or tablet pc through a wireless module 110 or 220.

Briefly, any idea which is not apart from setting a configuration program of an electronic apparatus through an operation on a mobile device and with a wireless module is concluded within the scope of the instant disclosure. Furthermore, any electronic apparatus with a charging battery to be switched between wired and wireless connection by a user though operating a software setting on a mobile device, or through an auto-determination from a microcontroller on an electronic apparatus, or a mechanical switch is within the scope of the instant disclosure.

To sum up, the electronic apparatus with the function of switching between a wired and wireless connection provided by the embodiments of the instant disclosure, along with the wireless module provided by the instant disclosure are able to achieve a simple configuration program setting, and the user will be able to switch between wired and wireless connection though operating a software setting on a mobile device, or through an auto-determination from a microcontroller on an electronic apparatus, or a mechanical switch, so as to adapt to different surroundings and bring up the convenience of operation.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An electronic apparatus with a function of switching between wire and wireless connection, comprising:
an electronic apparatus body, having a plug connection part, a first containing part, and a second containing part, and the electronic apparatus body connects to a host optionally;
a wireless module, equipped in the first containing part, wherein a configuration setting of the electronic apparatus is operated by the wireless module through a software setting of a mobile device; and
a charging battery, equipped in the second containing part, providing power for the electronic apparatus,
wherein when a connection is wired and connected from the plug connection part to the host, the electronic apparatus proceeds data communication with the host through the wireless module in a wired way; and
wherein a user is able to switch the electronic apparatus between wired and wireless connection through a software setting, an auto-determination from the microcontroller of the electronic apparatus, and a mechanical switch on the mobile device.

2. The electronic apparatus according to claim 1, when the electronic apparatus is connected to the host in a wireless way, the wireless module is a wireless communication interface.

3. The electronic apparatus according to claim 1, wherein the electronic apparatus body is a mouse, or a keyboard, or a headset, and the mobile device is either a phone or a tablet pc.

4. The electronic apparatus according to claim 1, wherein when the plug connection part is connected to the host in the wired way, the host will charge the charging battery.

5. The electronic apparatus according to claim 1, wherein a communication standard of the wireless module is either Bluetooth communication protocol or Zigbee communication protocol.

6. The electronic apparatus according to claim 1, wherein the electronic apparatus body comprises a signal processing module, connected to the wireless module and also connected to a charging battery through a charging circuit, and the signal processing module processes a data communication between the electronic apparatus and the host, and a configuration setting function of the electronic apparatus.

7. An electronic apparatus, comprising:
an electronic apparatus body having a plug connection part and a containing part, and the electronic apparatus body is connected from the plug connection part to a host through a transmission line, wherein the electronic apparatus proceeds a data communication with the host through the transmission line; and
a wireless module, equipped in the containing part, wherein a configuration setting of the electronic apparatus is operated with the wireless module and through an operation of a software setting of the mobile device.

8. The electronic apparatus according to claim 7, wherein the electronic apparatus body is a mouse, or a keyboard, or a headset, and the mobile device is either a phone or a tablet pc.

9. The electronic apparatus according to claim 7, wherein the electronic apparatus body comprises a signal processing module, connected to the wireless module and also connected to a charging battery through a charging circuit, and the signal processing module processes a data communication between the electronic apparatus and the host, and a configuration setting function of the electronic apparatus.

10. The electronic apparatus according to claim 7, the wireless module is a data transmission channel.
